(19) United States
(12) Patent Application Publication
(10) Pub. No.: US 2026/0070759 A1
(43) Pub. Date: Mar. 12, 2026

(54) SUBSTRATE HANDLING ROBOT LIFTING ARRANGEMENT AND METHOD THEREOF

(71) Applicant: ASM IP Holding B. V., Almere (NL)

(72) Inventors: Senthil Sivaraman, Yokohama-shi (JP); Taira Okabe, Kawasaki-shi (JP)

(21) Appl. No.: 19/321,414

(22) Filed: Sep. 8, 2025

Related U.S. Application Data
(60) Provisional application No. 63/693,670, filed on Sep. 11, 2024.

(51) Int. Cl. B66C 1/34; B66C 7/08; B66C 15/00

(52) U.S. Cl. CPC B66C 1/34; B66C 7/08; B66C 15/00; B66C 2700/0342

(57) ABSTRACT

A robot lifting arrangement is provided. The robot lifting arrangement includes a robot lifting crane that is configured to lift a substrate handling robot to an elevated position. The robot lifting arrangement also includes a track section that may extend from a chamber on the platform to an external area. Robot lifting crane may lift the robot from the chamber and transport it along the track to the external area for repair/maintenance or lift the robot from the external area and transport it along the track back to the chamber for installation into the chamber.

### CROSS-REFERENCE TO RELATED APPLICATION(S)

This Application claims the benefit of U.S. Provisional Application 63/693,670 filed on Sep. 11, 2024, the entire contents of which are incorporated herein by reference.

### FIELD OF THE INVENTION

The present disclosure generally relates to fabricating semiconductor devices. More particularly, the present disclosure relates to removal of substrate handling robot from a substrate handling chamber for maintenance such as repair or replacement.

### BACKGROUND OF THE INVENTION

Semiconductor processing system platforms commonly have a wafer transfer chamber housing a wafer transfer robot to transfer substrates between process modules and an equipment front-end module coupled to one another by the wafer transfer module. In some semiconductor processing systems, it may be necessary to remove the wafer transfer robot for maintenance and replacement, such as in the unlikely event that wafer transfer robot fails or the semiconductor processing system platform is repurposed to interface different process modules than originally provided.

In many conventional systems, removal and replacement of wafer transfer robots generally requires installing an overhead gantry. The overhead gantry typically spans the wafer transfer chamber, requires assembly onto the platform prior to use, disassembly and removal from the platform. Installation and removal requires overhead work to install and remove the overhead gantry. This can reduce availability of the semiconductor processing system, and currently has two separate gantries in systems having more than one wafer transfer chamber.

Further, in some conventional systems, wafer transfer robot is pulled out with help of pillars. Such removal mechanism may result in overhead work and complexity.

Any discussion, including discussion of problems and solutions, set forth in this section, has been included in this disclosure solely for the purpose of providing a context for the present disclosure and should not be taken as an admission that any or all of the discussion was known at the time the invention was made or otherwise constitutes prior art.

### BRIEF SUMMARY

A robot lifting arrangement is provided. A service platform to support the robot lifting arrangement is further provided. The service platform is installed above the semiconductor processing system having an equipment front-end module (EFEM), a load lock chamber connected to the EFEM, and a substrate handling chamber (SHC) connected to the load lock chamber. The robot lifting arrangement includes at least one track supported on the service platform. A robot lifting crane is configured to slide along the at least one track. The robot lifting crane is further configured to lift the substrate handling robot.

According to some embodiments, a robot lifting arrangement comprising: a service platform configured to support the robot lifting arrangement, wherein the service platform is installed above a semiconductor processing system that comprises an equipment front-end module (EFEM), a load lock chamber connected to the EFEM, and a substrate handling chamber (SHC) connected to the load lock chamber; a first track on the service platform; and a robot lifting crane configured to slide along the first track, wherein the robot lifting crane is further configured to lift a substrate handling robot.

In some embodiments, the robot lifting arrangement further comprising: a second track on the service platform, wherein the second track is disposed at an angle with respect to the first track. The robot lifting arrangement further comprising: a third track coupled to the first track and the second track; and a turntable coupled to the third track, wherein the turntable is configured to rotate along a first axis, wherein when the robot lifting crane is on the first track, the turntable is configured to align with the first track, and wherein when the robot lifting crane is on the second track, the turntable is configured to align with the second track. The turntable comprises a bottom safety lock mechanism configured to hold the turntable in place to align with the first track or the second track.

In some embodiments, the robot lifting crane comprises: a top section configured to lift the substrate handling robot; a base section configured to slide along the first track, wherein the base section comprises a base support section to rest the substrate handling robot; a middle section comprising a first middle end and a second middle end, wherein the first middle end is coupled to the top section and the second middle end is coupled to the base section. The robot lifting crane further comprises: a chain hoist configured to deploy and retract a chain to lift the substrate handling robot; and a hook assembly coupled to the chain to secure the substrate handling robot to the robot lifting crane. The robot lifting arrangement further comprising: a belt configured to constrain movement of the substrate handling robot after placement on the base support section. The top section comprises a horizontal section, and wherein the robot lifting crane comprises a sliding mechanism, wherein the sliding mechanism is coupled to the chain hoist, and wherein when the robot lifting crane has lifted the substrate handling robot, the sliding mechanism is configured to slide along the horizontal section and place the substrate handling robot on the base support section. The base section further comprises: a first leg; and a second leg, wherein the first leg and the second leg are separated by the base support section, and wherein the first leg and the second leg are equipped with an interface that aligns with the first track.

In some embodiments, the robot lifting arrangement further comprising a crane lock safety mechanism, wherein the crane lock safety mechanism is coupled to a first track end of the first track, wherein when the robot lifting crane is lifting the substrate handling robot, the crane lock safety mechanism is in a closed position, and wherein the crane lock safety mechanism is configured to open to move the robot lifting crane along the first track.

In some embodiments, the robot lifting arrangement further comprising: a raised hoop attached to an actuator of the substrate handling robot, wherein the raised hoop comprises: a plurality of lift bars; an attachment section supported by the plurality of lift bars; and an attachment mechanism coupled to the attachment section, wherein the attachment mechanism is configured to engage with the hook assembly of the robot lifting crane.

According to some embodiments, a method of transporting a substrate handling robot from a substrate handling chamber of a semiconductor processing system comprising lifting the substrate handling robot from the substrate handling chamber; and moving the substrate handling robot along a track installed over a service platform.

In some embodiments, the lifting the substrate handling robot from the substrate handling chamber comprises: extending a lifting chain toward the substrate handling robot, wherein the lifting chain is coupled to a hook assembly; attaching the hook assembly to an attachment mechanism of the substrate handling robot; and after the hook assembly is attached to the attachment mechanism, retracting the lifting chain with the substrate handling robot attached to the hook assembly.

In some embodiments, lifting the substrate handling robot from the substrate handling chamber further comprises placing the substrate handling robot onto a base support section, wherein the base support section is configured to move along the track. Placing the substrate handling robot onto the base support section further comprises sliding the substrate handling robot from an overhang position to a resting position such that, in the resting position, a bottom surface of an actuator of the substrate handling robot is coupled to a top surface of the base support section.

In some embodiments, moving the substrate handling robot along the track further comprises supporting the substrate handling robot on a robot lifting crane; aligning a first leg of the robot lifting crane with a first side of the track; aligning a second leg of the robot lifting crane with a second side of the track; and moving the robot lifting crane along the track.

In some embodiments, moving the robot lifting crane along the track further comprises moving the robot lifting crane along a first track section of the track; and moving the robot lifting crane along a second track section of the track, wherein the first track section and the second track section form an angled path.

According to some embodiments, a robot lifting arrangement comprising at least one rail section; and a robot lifting crane configured to slide along the at least one rail section, wherein the robot lifting crane is further configured to lift a substrate handling robot.

In some embodiments, the at least one rail section comprises: a first rail section; a second rail section; a third rail section movable about a first axis to rotate between a first position and a second position, wherein the third rail section is in alignment with the first rail section in the first position, and wherein the third rail section is in alignment with the second rail section in the second position.

In some embodiments, the robot lifting arrangement further comprising a turntable configured to rotate about the first axis, wherein the third rail section is coupled to the turntable.

This summary is provided to introduce a selection of concepts in a simplified form. These concepts are described in further detail in the detailed description of examples of the disclosure below. This summary is not intended to identify key features or essential features of the claimed subject matter, nor is it intended to be used to limit the scope of the claimed subject matter.

### BRIEF DESCRIPTION OF DRAWINGS

These and other features, aspects, and advantages of the invention disclosed herein are described below with reference to the drawings of certain embodiments, which are intended to illustrate and not to limit the invention.

FIG. 1 illustrates a robot lifting system for a substrate processing system in accordance with example embodiments of the invention.

FIG. 2 illustrates a robot lifting system for a substrate processing system of FIG. 1 in accordance with example embodiments of the invention.

FIG. 3 illustrates a top perspective view of a substrate handling robot of a semiconductor processing system of FIG. 1 in accordance with example embodiments of the invention.

FIG. 4 illustrates a perspective view of substrate handling robot lifted from the substate handling chamber of a substrate processing system of FIG. 1 in accordance with example embodiments of the invention.

FIGS. 5A, 5B and 5C illustrate a robot lifting crane for lifting a substrate handling robot of FIG. 1, in accordance with example embodiments of the invention.

FIGS. 6A, 6B and 6C illustrate a turntable for transporting a substrate handling robot of FIG. 1 in accordance with example embodiments of the invention.

FIG. 7 illustrates a flow diagram of a method of transporting a substrate handling robot from a substrate handling chamber of a semiconductor processing system of FIG. 1 in accordance with example embodiments of the invention.

It will be appreciated that elements in the figures are illustrated for simplicity and clarity and have not necessarily been drawn to scale. For example, the relative size of some of the elements in the figures may be exaggerated relative to other elements to help improve understanding of illustrated embodiments of the present invention.

### DETAILED DESCRIPTION

Reference will now be made to the drawings wherein like reference numerals identify similar structural features or aspects of the invention. The systems and methods of the present disclosure may be in semiconductor processing systems employed to fabricate semiconductor devices, such as in semiconductor processing systems employed to deposit material layers using chemical vapor deposition (CVD) and atomic layer deposition (ALD) techniques during the fabrication of logic and memory devices, though the present disclosure is not limited to any semiconductor processing operation or to the fabrication of any particular semiconductor device in general.

As used herein, the term “substrate” may refer to any underlying material or materials, including any underlying material or materials that may be modified, or upon which, a device, a circuit, or a film may be formed. The “substrate” may be continuous or non-continuous; rigid or flexible; solid or porous; and combinations thereof. The substrate may be in any form, such as a powder, a plate, or a workpiece. Substrates in the form of a plate may include wafers in various shapes and sizes. Wafers may be 200 millimeters in diameter, 300 millimeters, or even 450 millimeters in diameter. Substrates may be formed from one or more semiconductor materials including by way of non-limiting example silicon, silicon germanium, silicon oxide, gallium arsenide, gallium nitride and silicon carbide.

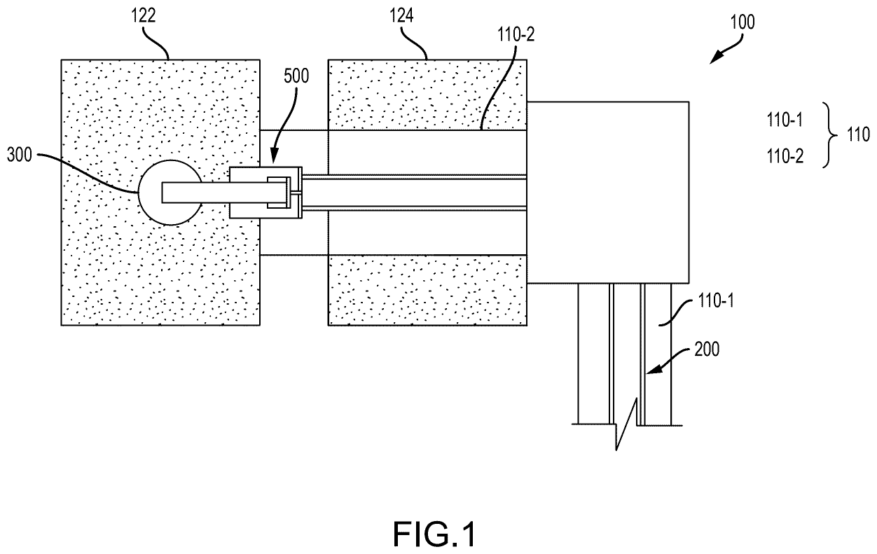

Referring to FIG. 1, a robot lifting system 100 for a substrate processing system is illustrated. Substrate processing system may include a Front Opening Unified Pod (FOUP), an equipment front end module (EFEM), a load lock chamber, one or more substrate handling chambers (SHC) (122, 124), one or more processing modules, and a control processor (that further includes memory). Generally, unprocessed wafers are accessed by the substrate processing system in FOUP. The EFEM includes a front-end robot (not shown) that is configured to obtain wafers from the FOUP and readied to be transported to the load lock chamber. The transfer of wafers from load lock chamber to a processing module is handled by a substrate handling robot 300 (also referred to as a robot) in the substrate handling chamber 122, 124.

In the example shown in FIG. 1, substrate processing system includes a cluster-type platform with process modules configured to deposit a material layer on a substrate using various deposition techniques (for example, atomic layer deposition (ALD)). This for illustration and description purposes only and is non-limiting. As will be appreciated by those of skill in the art in view of the present disclosure, substrate processing systems configured for other material layer deposition operations as well as semiconductor processing systems configured for processing operations other than material layer deposition can also benefit from the present disclosure.

As shown in FIG. 1, robot lifting system 100 includes a service platform 110. Service platform 110 is strategically installed above the semiconductor processing system and is designed to support and facilitate maintenance operations. In example embodiments, service platform 110 includes two sections: a first service platform area 110-2 installed above the semiconductor processing system (that is, above the one or more load lock chambers, the one or more substrate handling chambers and/or the EFEM), and a second service platform area 110-1 that is connected to the first service platform area and leads to an area external to the semiconductor processing system. In example embodiments, the second service platform area 110-1 is connected to the first service platform area 110-2 at an angle (that is, first and second service platform areas are not aligned to each other in a straight manner). In some embodiments, the second service platform area 110-1 is disposed at an angle with respect to the first service platform area 110-2.

As further shown in FIG. 1, robot lifting system 100 further includes a robot lifting crane 500 (also referred to as a crane) and at least one track 200. Robot lifting crane 500 is configured to lift substrate handling robot 300 vertically out of substrate handling chamber 122 and secure it for transport. Once the substrate handling robot 300 is secure, robot lifting crane 500 can be moved along the at least one track 200 to a service area on the service platform 110 or removed entirely for repair and/or replacement.

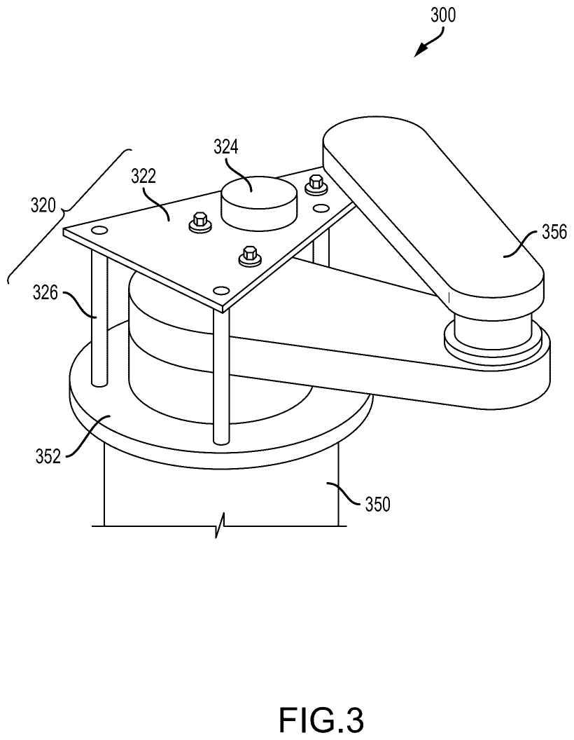

Referring now to FIG. 3, a top perspective view of a substrate handling robot 300 is illustrated. Substrate handling robot 300 includes an actuator 350 having an actuator top section 352 (e.g., an actuator top surface). As further shown in FIG. 3, substrate handling robot 300 may include single or dual arms 356. Substrate handling robot 300 further includes a raised hoop 320 that enables robot lifting crane 500 to attach to the substrate handling robot 300 and further secure it for transport.

As shown in FIG. 3, raised hoop 320 includes one or more lift bars 326 that are attached to the actuator top section 352. Raised hoop 320 further includes an attachment section 322 that is supported on the lift bars 326. In example embodiments, three lift bars 326 are included in raised hoop 320 and a triangular shaped attachment section 322 is supported. However, any other embodiments functioning in a similar manner may be utilized. Finally, raised hoop 320 includes an attachment mechanism 324. Attachment mechanism 324 is configured to engage with robot lifting crane 500.

As shown in FIG. 3, including this type of raised hoop 320 allows the robot to function without the lifting mechanism interfering with, disturbing or damaging the structure or operation of the arms of the robot. Further, raised hoop 320 is designed and located over actuator 350 with attachment points (such as attachment mechanism 324) that are strategically reinforced to handle the weight and stress of being lifted and minimize tilting or shifting during the lifting operation.

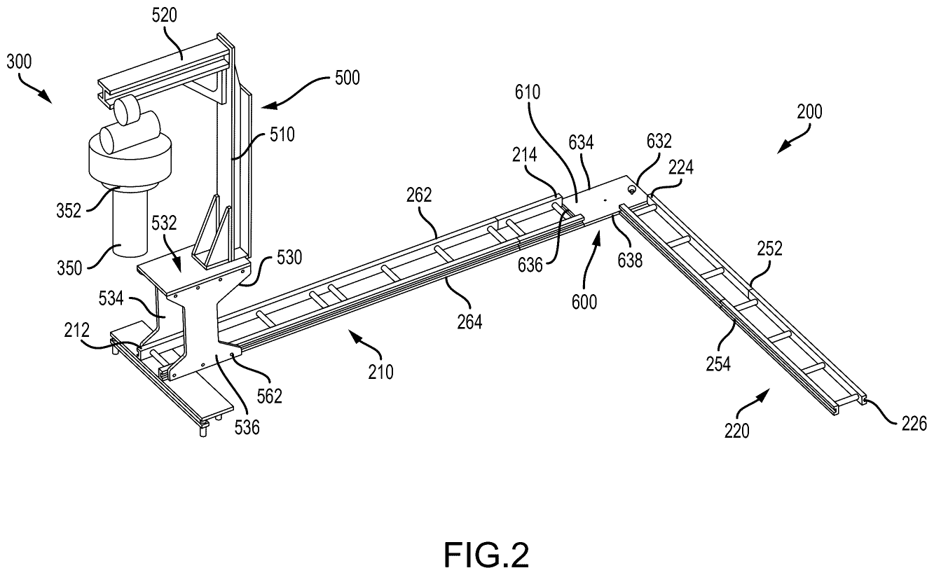

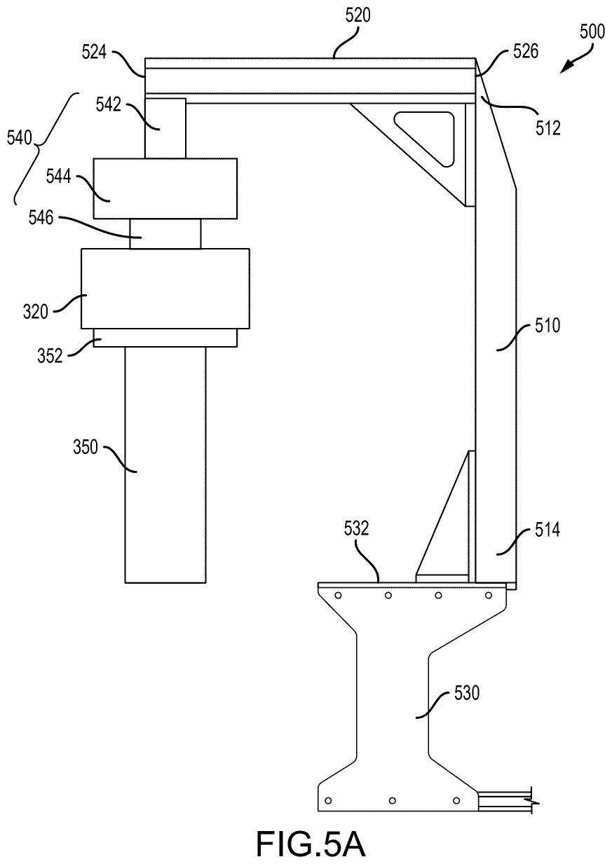

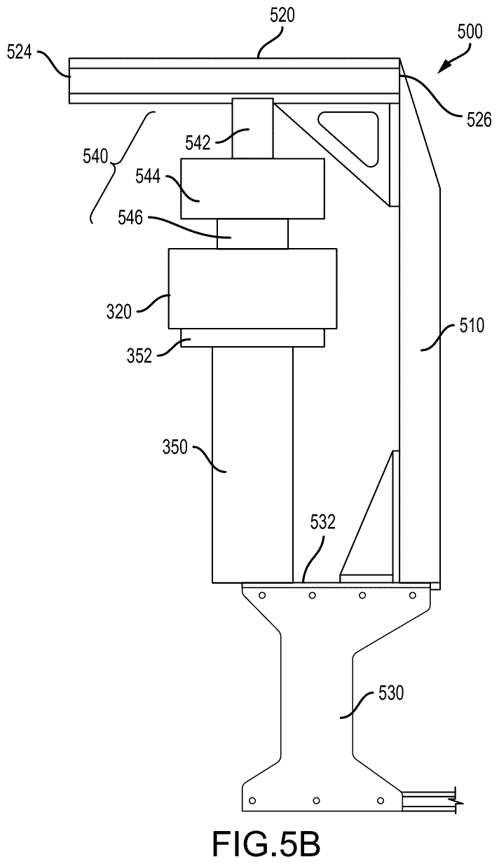

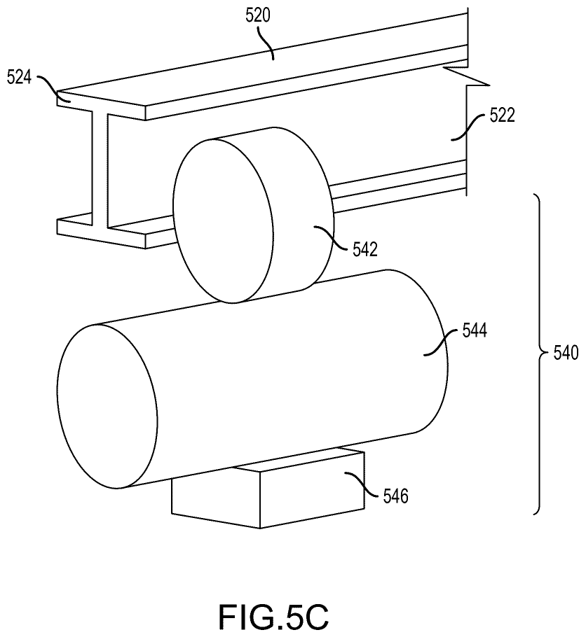

Referring now to FIGS. 2, 4, 5A, 5B and 5C, structure and operation of a robot lifting crane 500 is illustrated. As shown in FIGS. 2, 5A and 5B, robot lifting crane 500 includes three sections: a base section 530, a top section 520 and a middle section 510. In example embodiments, base section 530, top section 520 and middle section 510 can be separate pieces that are attached together. In example embodiments, base section 530, top section 520 and middle section 510 are a single piece.

Robot lifting crane 500 further includes a lifting mechanism 540 that is configured to lift the substrate handling robot 300 out of the substrate handling chamber. As shown in FIG. 5C, lifting mechanism 540 includes hook assembly 546 that is configured to engage securely with the substrate handling robot 300 at attachment mechanism 324. In example embodiments, hook assembly 546 may include a mechanical hook, a clamp or any other gripping mechanism that interfaces with designated attachment points of attachment mechanism 324.

Lifting mechanism 540 further includes a chain hoist 544 that controls the deployment and retraction of a durable lifting chain. The lifting chain may be attached to hook assembly 546. In example embodiments, the lifting chain may be composed of high-strength material capable of supporting the weight of the substrate handling robot 300.

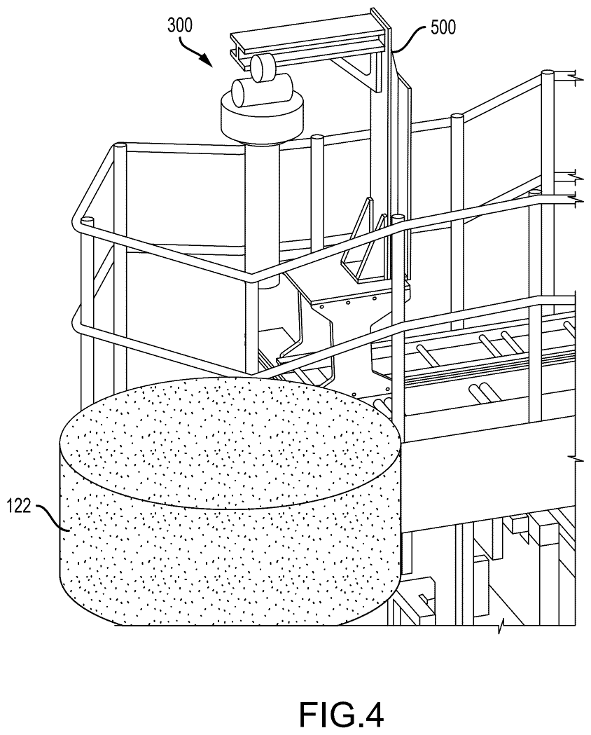

In operation, when at least a part of the robot lifting crane 500 is positioned above the substrate handling robot 300, chain hoist 544 is activated to lower the lifting chain and descend towards robot 300 (See FIG. 4). As lifting chain is lowered, hook assembly 546 is aligned with attachment points of attachment mechanism 324. When hook assembly 546 is engaged with attachment mechanism 324, a locking mechanism within hook assembly 546 is utilized to ensure that hook assembly 546 remains securely attached to the substrate handling robot 300 during the lifting process. In example embodiments, locking mechanism may include latches, clamps or any other known or available locking mechanism to securely attach the hook assembly 546 with attachment mechanism 324.

After securing hook assembly 546 with attachment mechanism 324, chain hoist 544 is activated to retract the lifting chain and wind it back into place while lifting the substrate handling robot 300. In example embodiments, the substrate handling robot 300 is lifted vertically (See FIG. 4). In example embodiments, chain hoist 544 is configured to lift the substrate handling robot 300 to predetermined height (e.g., a desired height). In example embodiments, chain hoist 544 allows control over speed and height of the lift.

As shown in FIGS. 5A and 5C, top section 520 includes a first top end 524 and a second top end 526. Top section 520 includes a horizontal section 522 that spans from first top end 524 to second top end 526. In example embodiments, horizontal section 522 is recessed on either side to have an “I” shaped cross section such that top section 520 is able to accommodate sliding along the horizontal section 522. After the substrate handling robot 300 is lifted using chain hoist 544, the substrate handling robot 300 may slide along horizontal section 522. In example embodiments, second top end 526 is attached to middle section 510.

As shown in FIG. 2, base section 530 is aligned with at least one track 200 and further configured to slide along track 200. Base section 530 includes three sections a first base leg 534, a second base leg 536 and a flat base support section 532 (also referred to as a base support section). The first base leg 534 and second base leg 536 are opposite and parallel to each other. The first base leg 534 and second base leg 536 are separated from each other by the flat base support section 532. In example embodiments, first base leg 534 and second base leg 536 are “I” shaped to have a top and bottom edge that are longer than the middle. As further shown in FIG. 2, each leg 534 and 536 is equipped with an interface that aligns with track 200. The interface may include one or more of wheels, rollers, sliders, or any other interface mechanism (such as magnetic or electric) to allow legs 534 and 536 to move smoothly along track 200.

In example embodiments, the flat base support section 532 is designed as a resting surface for robot 300 during transport. As further shown in FIGS. 2, 5A and 5B, middle section 510 of robot lifting crane 500 is a pillar-like section that extends from a first middle end 512 to a second middle end 514. First middle end 512 is attached to second top end 526, and second middle end 514 is attached to base support section 532. Accordingly, top section 520 and base section 530 are separated by a middle section 510.

Referring briefly back to FIG. 5C, in example embodiments, lifting mechanism 540 includes a sliding feature 542 that is attached to chain hoist 544. Sliding feature 542 is coupled to the top section 520 and configured to move back and forth along horizontal section 522 from first top end 524 to second top end 526. In operation, the substrate handling robot 300 is lifted using chain hoist 544 and is in the position as seen in FIG. 5A.

However, the substrate handling robot 300 in such an orientation can be complex due to the resultant overhang. Thus, in example embodiments, the substrate handling robot 300 is moved to the position as shown in FIG. 5B utilizing sliding feature 542. In example embodiments, the substrate handling robot 300 is rested on flat base support section 532, as illustrated in FIG. 5B. Such an orientation can significantly mitigate overhang. Since hook assembly 546 is still attached to raised hoop 320, robot 300 is still securely in place during transport. In example embodiments, a belt may be additionally used to further secure substrate handling robot 300.

After substrate handling robot 300 is secured with robot lifting crane 500, robot lifting crane 500 can move along track 200. First base leg 534 and second base leg 536 are equipped with interface that aligns along track 200. The alignment of first and second base legs 536 and 534 along track 200 ensures that crane 500 remains stable and accurately positioned during operations. During the lifting operation as discussed above, one or both legs 536 and 534 are locked to track 200. In example embodiments, one or more lock pins 562 may be used to lock legs 536 and 534 with track 200. In example embodiments, any other suitable locking mechanism may be utilized.

In example embodiments, track 200 may include a first track section 210 and a second track section 220. In example embodiments, first track section 210 is located on the first service platform area 110-2 and second track section 220 is located on the second service platform area 110-1. As shown in FIG. 2, first track section 210 extends from a first track section first end 212 (i.e., a first end of the first track section 210) to a first track section second end 214 (i.e., a second end of the first track section 210). Further, second track section 220 extends from second track section first end 224 (i.e., a first end of the second track section 220) to second track section second end 226 (i.e., a second end of the second track section 220). First track section 210 extends lengthwise along the first service platform area 110-2 and second track section 220 extends lengthwise along the second service platform area 110-1. Thus, first track section 210 and second track section 220 are not parallel to each other. In such an embodiment, lock pins 562 may be used to align and lock legs 536 and 534 with the first track section 210 at the first track section first end 212.

During lifting operation as discussed with reference to FIGS. 4, 5A-5C, lock pins 562 are in a closed position to disallow movement of robot lifting crane. After substrate handling robot 300 is secured to robot lifting crane 500, lock pins 562 can be set in an open position to allow movement of robot lifting crane 500 along track 200. In the example embodiment shown in FIG. 2, crane 500 may move along first track section 210 from the first end 212 to the second end 214, crane 500 may then switch to new position to align with second track section 220 to move from the first end 224 to the second end 226.

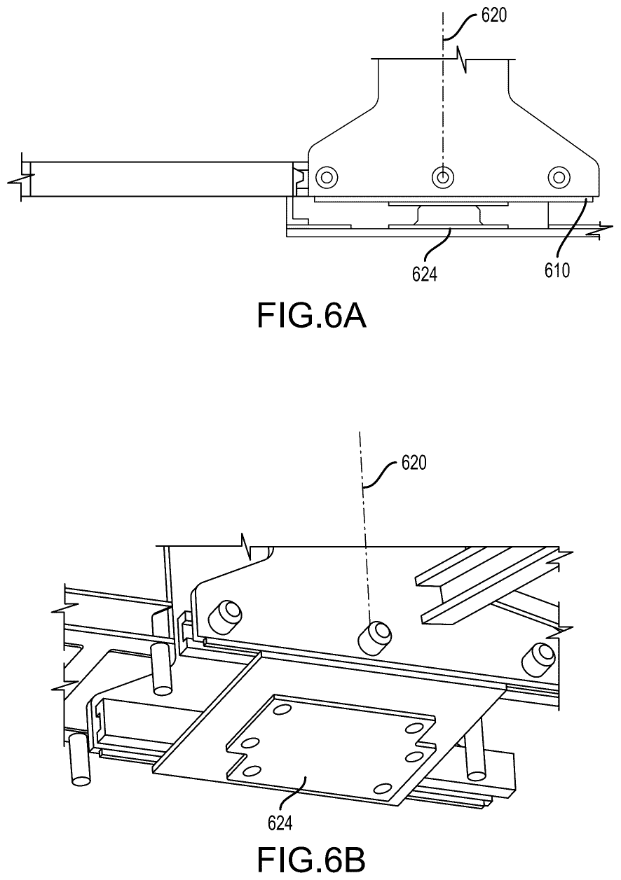

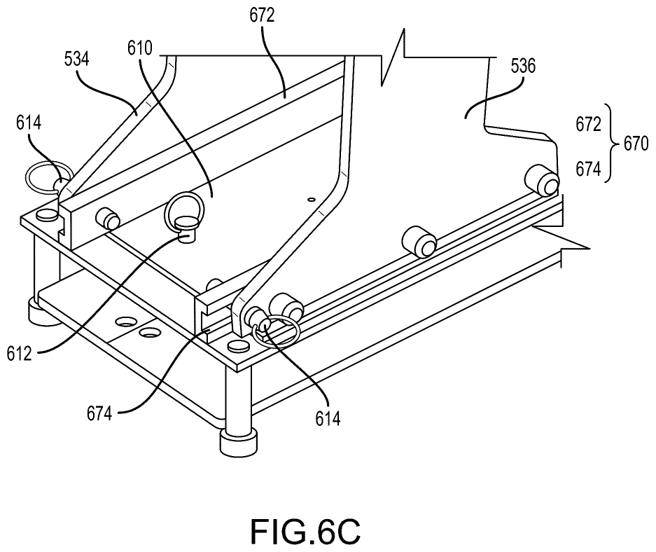

In example embodiments, crane 500 may switch alignment between first track section 210 and second track section 220 using a turntable mechanism 600 (also referred to as turntable). FIGS. 2 and 6A-6C illustrate structure and operation of turntable 600 illustrated in FIG. 2. As shown in FIG. 6A, turntable 600 includes a turning mechanism 624 and turntable flat section 610. In example embodiments, turntable flat section 610 is a rectangular section having a first edge 632, a second edge 634, a third edge 636 and a fourth edge 638. First edge 632 and third edge 636 are parallel to each other, as illustrated in FIG. 2. Similarly, second edge 634 and fourth edge 638 are parallel to each other.

As further shown in FIG. 2 and FIG. 6A, first and third edges 632 and 636 have the same width as the width of the track 200. Further, as shown in FIG. 6C, track 200 includes a third track section 670 having a first side 672 and a second side 674. In example embodiments, first side 672 is coupled with edge 638 and second side 674 is coupled with edge 634, respectively. In example embodiments, first side 672 may be aligned along at least one of sides 262, 264, 252 or 254. Similarly, in example embodiments, second side 674 may be aligned along at least one of sides 262, 264, 252 or 254. In some embodiments, the first side 672 may be parallel to at least one of sides 262, 264, 252 or 254 of the track 200, and the second side 674 may be parallel to at least one of sides 262, 264, 252 or 254 of the track 200.

In operation, when robot lifting crane 500 is traveling along a first track section 210, turntable flat section 610 is aligned with first track section 210. Specifically, at least one of first edge 632 and third edge 636 is coupled to second end 214 of first track section 210. Further, second edge 634 and fourth edge 638 are aligned with a first side 262 and a second side 264, respectively, of first track section 210 (See FIG. 6A). Thus, robot lifting crane 500 can move along first track section 210 until it rests over turntable flat section 610 along third track section 670.

Turntable 600 may then rotate about an axis 620 via turning mechanism 624. Turntable 600 may rotate until second edge 634 and fourth edge 638 are aligned with a first side 252 and second side 254 of second track section 220. After rotating at least one of first edge 632 and third edge 634 is coupled to the first end 224 of second track section 220. Robot lifting crane 500 may then move along second track section 220 until it reaches the second end 226 of second track section 220. Axis 620 is perpendicular to turntable flat section 610.

In example embodiments, a lock pin 612 or any other locking mechanism may be used to lock the position of turntable 600. For example, turntable 600 may be locked in a first position using lock pin 612. In the first position, turntable 600 is aligned along the first track section 210, the first track section 210 abutting the turntable 600. Once aligned, robot lifting crane 500 may slide from first track section 210 to third track section 670. Legs 534 and 536 can then be locked on to sides 672 and 674 via a locking mechanism 614. In example embodiments, locking mechanism 614 may be a lock pin. After the robot lifting crane 500 is locked to turntable 600, lock pin 612 may be opened to allow turntable 600 to rotate about an axis 620. When the turntable 600 is rotated to a second position, turntable 600 may be locked in the second position using lock pin 612. In the second position, turntable 600 is aligned along the second track section 220, the second track section 220 abutting the turntable 600. Once aligned, robot lifting crane 500 may slide from the third track section 670 to second track section 220. Legs 534 and 536 can be unlocked to release locking mechanism 614 and allow robot lifting crane 500 to slide along the second track section 220.

Once robot lifting crane 500 reaches the second end 226 of second track section 220, substrate handling robot 300 may be unsecured from robot lifting crane 500 for further maintenance. The process of unloading substrate handling robot 300 is similar to lifting substrate handling robot 300. That is, the belt constraining substrate handling robot 300 to robot lifting crane 500 is unsecured. Substrate handling robot 300 may then slide along horizontal section 522 from the second top end 526 to the first top end 524. Accordingly, substrate handling robot 300 slides from resting position (seen in FIG. 5B) to overhang position (seen in FIG. 5A). Chain hoist 544 may then be activated to lower the lifting chain and descend. After lifting chain (and subsequently, substrate handling robot 300) is lowered to a predetermined position/height (e.g., a desired position/height), hook assembly 546 is disengaged from the attachment mechanism 324 to release robot 300 from the robot lifting crane 500.

FIGS. 2-6C generally describe a robot lifting arrangement that includes lifting a substrate handling robot 300 from a SHC 122 using a robot lifting crane 500 and transporting substrate handling robot 300 to an external service area using track(s) 200 and turntable mechanism 600. However, the same robot lifting arrangement may also be utilized to lift a robot 300 from an external service area using a robot lifting crane 500, securing robot 300 with robot lifting crane 500 by resting it on a base section 530 of robot lifting crane 500, sliding/moving robot lifting crane 500 along one or more track(s) 200 and turntable mechanism 600, and installing robot 300 into a SHC 122. Installing robot 300 into SHC 122 may further include sliding from resting position (seen in FIG. 5B) to overhang position (seen in FIG. 5A), activating chain hoist 544 to lower the lifting chain into SHC 122, and disengaging hook assembly 546 from attachment mechanism 324 to install robot 300 into SHC 122.

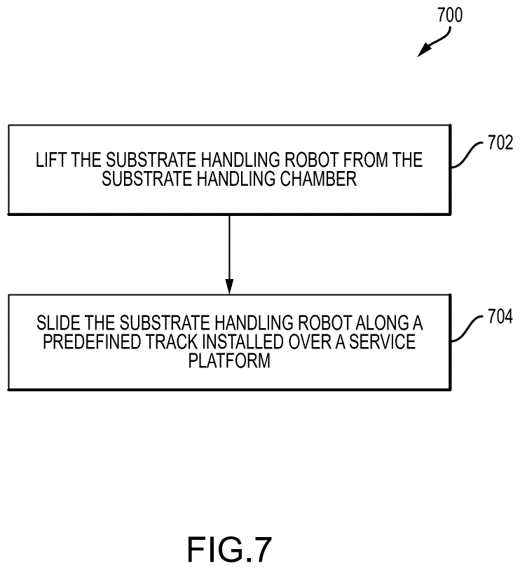

FIG. 7 illustrates a method 700 of transporting a substrate handling robot, such as robot 300, from a substrate handling chamber, such as chamber 122, of a semiconductor processing system. Method 700 includes lifting the substrate handling robot from the substrate handling chamber, as shown with box 702. In example embodiments, method 700 further includes extending a lifting chain into the substrate handling robot. The lifting chain is coupled to a hook assembly, such as hook assembly 546. Method 700 further includes attaching the hook assembly with an attachment mechanism, such as attachment mechanism 324, on the substrate handling robot. After the hook assembly is securely attached with the attachment mechanism, method 700 further includes retracting the lifting chain with the substrate handling robot attached to the hook assembly.

In example embodiments, method 700 includes supporting the substrate handling robot on a base support section, such as base section 530, wherein the base support section is configured to move along the predefined track. In further example embodiments, method 700 includes sliding the substrate handling robot from an overhang position (as seen in FIG. 5A) to a resting position (as seen in FIG. 5B) such that in the resting position, the bottom surface of an actuator of the substrate handling robot is coupled to the top surface of the base support section.

Method 700 further includes moving the substrate handling robot along a predefined track, such as track 200, installed over a service platform 110, as shown with box 702. In example embodiments, method 700 includes supporting the substrate handling robot on a robot lifting crane, aligning a first leg, such as leg 534, of the robot lifting crane with a first side, such as side 262, of the predefined track, aligning a second leg, such as leg 536, of the robot lifting crane with a second side, such as side 262, of the predefined track, and moving the robot lifting crane along the predefined track.

In example embodiments, method 700 includes moving the robot lifting crane along a first track section, such as first track section 210, wherein the predefined track comprises the first track section, wherein the first track section has a first end, such as a first end 212 of the first track section and a second end, such as a second end 214, of the first track section. Method 700 further includes moving the robot lifting crane along a second track section, such as second track section 220, wherein the predefined track comprises the second track section, wherein the second track section has a first end, such as a first end 224, of the second track section and a second end, such as a second end 226, of the second track section. First track section and the second track section form an angled path. The angle path forms an angle that is less than 180 degrees. In some embodiments, the second track section 220 is disposed at an angle with respect to the first track section 210.

In example embodiments, method 700 includes aligning a turntable, such as turntable 600 (also referred to as a turntable mechanism) with a third track section, such as third track section 670, to the first track section wherein the turntable is abutting the first track section and the second track section. In example embodiments, method 700 further includes moving the robot lifting crane to the third track section, wherein the first track section abuts the turntable. Method 700 further includes rotating the turntable to align the third track section with the second track section, and moving the robot lifting crane to the second track section.

In example embodiments, method 700 further includes locking the turntable in place in a first position, moving the robot lifting crane from the first track section to the third track section, rotating the turntable about a first axis from the first position to a second position and moving the robot lifting crane to the second track section.

Although this disclosure has been provided in the context of certain embodiments and examples, it will be understood by those skilled in the art that the disclosure extends beyond the specifically described embodiments to other alternative embodiments and/or uses of the embodiments and obvious modifications and equivalents thereof. In addition, while several variations of the embodiments of the invention have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the invention. Thus, it is intended that the scope of the disclosure should not be limited by the particular embodiments described above.

The headings provided herein, if any, are for convenience only and do not necessarily affect the scope or meaning of the devices and methods disclosed herein.

1. A robot lifting arrangement comprising:
a service platform configured to support the robot lifting arrangement, wherein the service platform is installed above a semiconductor processing system that comprises an equipment front-end module (EFEM), a load lock chamber connected to the EFEM, and a substrate handling chamber (SHC) connected to the load lock chamber;
a first track on the service platform; and
a robot lifting crane configured to slide along the first track, wherein the robot lifting crane is further configured to lift a substrate handling robot.

2. The robot lifting arrangement of claim 1, further comprising:
a second track on the service platform, wherein the second track is disposed at an angle with respect to the first track.

3. The robot lifting arrangement of claim 2, further comprising:
a third track coupled to the first track and the second track; and
a turntable coupled to the third track, wherein the turntable is configured to rotate along a first axis, wherein when the robot lifting crane is on the first track, the turntable is configured to align with the first track, and wherein when the robot lifting crane is on the second track, the turntable is configured to align with the second track.

4. The robot lifting arrangement of claim 3, wherein the turntable comprises:
a bottom safety lock mechanism configured to hold the turntable in place to align with the first track or the second track.

5. The robot lifting arrangement of claim 1, wherein the robot lifting crane comprises:
a top section configured to lift the substrate handling robot;
a base section configured to slide along the first track, wherein the base section comprises a base support section to rest the substrate handling robot; and
a middle section comprising a first middle end and a second middle end, wherein the first middle end is coupled to the top section and the second middle end is coupled to the base section.

6. The robot lifting arrangement of claim 5, wherein the robot lifting crane further comprises:
a chain hoist configured to deploy and retract a chain to lift the substrate handling robot; and
a hook assembly coupled to the chain to secure the substrate handling robot to the robot lifting crane.

7. The robot lifting arrangement of claim 5, further comprising:
a belt configured to constrain movement of the substrate handling robot after placement on the base support section.

8. The robot lifting arrangement of claim 6,
wherein the top section comprises a horizontal section, and
wherein the robot lifting crane comprises a sliding mechanism, wherein the sliding mechanism is coupled to the chain hoist, and wherein when the robot lifting crane has lifted the substrate handling robot, the sliding mechanism is configured to slide along the horizontal section and place the substrate handling robot on the base support section.

9. The robot lifting arrangement of claim 5, wherein the base section further comprises:
a first leg; and
a second leg,
wherein the first leg and the second leg are separated by the base support section, and
wherein the first leg and the second leg are equipped with an interface that aligns with the first track.

10. The robot lifting arrangement of claim 9, further comprising a crane lock safety mechanism,
wherein the crane lock safety mechanism is coupled to a first track end of the first track,
wherein when the robot lifting crane is lifting the substrate handling robot, the crane lock safety mechanism is in a closed position, and
wherein the crane lock safety mechanism is configured to open to move the robot lifting crane along the first track.

11. The robot lifting arrangement of claim 6, further comprising:
a raised hoop attached to an actuator of the substrate handling robot,
wherein the raised hoop comprises:
a plurality of lift bars;
an attachment section supported by the plurality of lift bars; and
an attachment mechanism coupled to the attachment section, wherein the attachment mechanism is configured to engage with the hook assembly of the robot lifting crane.

12. A method of transporting a substrate handling robot from a substrate handling chamber of a semiconductor processing system, the method comprising:
lifting the substrate handling robot from the substrate handling chamber; and
moving the substrate handling robot along a track installed over a service platform.

13. The method of claim 12, wherein lifting the substrate handling robot from the substrate handling chamber comprises:
extending a lifting chain toward the substrate handling robot, wherein the lifting chain is coupled to a hook assembly;
attaching the hook assembly to an attachment mechanism of the substrate handling robot; and
after the hook assembly is attached to the attachment mechanism, retracting the lifting chain with the substrate handling robot attached to the hook assembly.

14. The method of claim 13, wherein lifting the substrate handling robot from the substrate handling chamber further comprises:
placing the substrate handling robot onto a base support section, wherein the base support section is configured to move along the track.

15. The method of claim 14, wherein placing the substrate handling robot onto the base support section further comprises:
sliding the substrate handling robot from an overhang position to a resting position such that, in the resting position, a bottom surface of an actuator of the substrate handling robot is coupled to a top surface of the base support section.

16. The method of claim 12, wherein moving the substrate handling robot along the track further comprises:
supporting the substrate handling robot on a robot lifting crane;
aligning a first leg of the robot lifting crane with a first side of the track;
aligning a second leg of the robot lifting crane with a second side of the track; and
moving the robot lifting crane along the track.

17. The method of claim 16, wherein moving the robot lifting crane along the track further comprises:
moving the robot lifting crane along a first track section of the track; and
moving the robot lifting crane along a second track section of the track,
wherein the first track section and the second track section form an angled path.

18. A robot lifting arrangement comprising:
at least one rail section; and
a robot lifting crane configured to slide along the at least one rail section, wherein the robot lifting crane is further configured to lift a substrate handling robot.

19. The robot lifting arrangement of claim 18, wherein the at least one rail section comprises:
a first rail section;
a second rail section;
a third rail section movable about a first axis to rotate between a first position and a second position, wherein the third rail section is in alignment with the first rail section in the first position, and wherein the third rail section is in alignment with the second rail section in the second position.

20. The robot lifting arrangement of claim 19, further comprising a turntable configured to rotate about the first axis, wherein the third rail section is coupled to the turntable.
